(19) United States
(12) Patent Application Publication
(10) Pub. No.: US 2010/0057487 A1
(43) Pub. Date: Mar. 4, 2010

(54) CONFIGURATION FOR LANGUAGE INTERPRETER CERTIFICATION

(76) Inventors: Yung-Chung Heh, Pacific Grove, CA (US); Danyune Geertsen, Carmel, CA (US)

Correspondence Address: PATENT INGENUITY, PC, 520 BROADWAY, SUITE 350, SANTA MONICA, CA, 90401, US

(21) Appl. No.: 12/493,076

(22) Filed: Jun. 26, 2009

Related U.S. Application Data
(63) Continuation-in-part of application No. 12/199,696, filed on Aug. 27, 2008.

(51) Int. Cl. G06Q 99/00; G09B 19/00; G06Q 50/00; G06Q 90/00

(52) U.S. Cl. 705/1; 434/219; 705/500

(57) ABSTRACT

A process provides a screening of a candidate on a prerequisite. Further, the process provides a written examination to a qualified candidate. The qualified candidate passes the screening. In addition, the process provides an oral examination to the qualified candidate if the qualified candidate passes the written examination. The process also provides examination results to the qualified candidate. Finally, the process provides certification to the qualified candidate if the qualified candidate passes both the written examination and the oral examination.

### RELATED APPLICATIONS

This application is a continuation-in-part application of U.S. patent application Ser. No. 12/199,696 entitled “Method and Apparatus for Language Interpreter Certification” by Yung-Chung Heh, et al., filed on Aug. 27, 2008, the content of which is incorporated herein by reference in its entirety.

### BACKGROUND

1. Field

This disclosure generally relates to the field of language interpretation. More particularly, the disclosure relates to language interpreter certification.

2. General Background

As the global marketplace continues to expand and immigration continues to grow, public and private organizations provide services for customers who do not speak English. As a result, a large demand for competent language interpreters exists.

However, many language interpreters may only be capable in the general utilization of the language and not the requisite language interpretation skills and the subject matter knowledge. The subject matter knowledge may also be called the domain knowledge. For example, a language interpreter may be able to translate Spanish into English, but may not be familiar with the specific medical terms utilized in Spanish.

Further, no standardized method exists for evaluating the proficiency of language interpreters. Accordingly, businesses do not have a viable mechanism for determining whether a language interpreter will be proficient in the language and also be proficient in the specific business needs of the particular business.

### SUMMARY

In one aspect of the disclosure, a process is provided. The process provides a screening of a candidate on a prerequisite. Further, the process provides a written examination to a qualified candidate. The qualified candidate is a candidate that passes the screening. In addition, the process provides an oral examination to the qualified candidate if the qualified candidate passes the written examination. The process also provides examination results to the qualified candidate. Further, the process provides certification to the qualified candidate if the qualified candidate passes both the written examination and the oral examination.

In another aspect of the disclosure, a system is provided. The system includes a web-based screening module that provides, through a web server, a screening of a candidate on a prerequisite. Further, the system includes a web-based written examination module that provides, through the web server, a written examination that is provided to a qualified candidate. The qualified candidate is a candidate that passes the screening. In addition, the system includes an oral examination automated system that provides an oral examination to the qualified candidate if the qualified candidate passes the written examination. The system includes an examination results delivery module that delivers examination results to the qualified candidate. Further, the system includes a certification module that provides certification to the qualified candidate if the qualified candidate passes both the written examination and the oral examination.

In yet another aspect of the disclosure, a computer program product is provided. The computer program product includes a computer useable medium having a computer readable program. The computer readable program when executed on a computer causes the computer to provide a screening of a candidate on a prerequisite. Further, the computer is caused to provide a written examination to a qualified candidate. The qualified candidate is a candidate that passes the screening. In addition, the computer is caused to provide an oral examination to the qualified candidate if the qualified candidate passes the written examination. The computer is also caused to provide examination results to the qualified candidate. Finally, the computer is caused to provide certification to the qualified candidate if the qualified candidate passes both the written examination and the oral examination.

In another aspect of the disclosure, a process is provided. The process provides, if a language interpreter candidate is a beginning level language interpreter candidate, a preliminary assessment and a language proficiency test. Further, the process provides, if the language interpreter has a predetermined amount of entry level language interpreter experience or has completed beginning level language interpreter requirements, an interpreter skills assessment test. In addition, the process provides, if the language interpreter candidate has a predetermined amount of professional level language interpreter experience, a predetermined amount of training in a subject matter field associated with the subject matter skill set, or has passed the interpreter skills assessment test, a subject matter skill set language interpretation certification test by (i) providing a screening of a candidate on a prerequisite, (ii) providing a written examination to a qualified candidate, and (iii) providing an oral examination to the qualified candidate if the qualified candidate passes the written examination. The qualified candidate is a candidate that passes the screening. In addition, the process provides certification to the qualified candidate if the qualified candidate passes both the written examination and the oral examination.

In yet another aspect of the disclosure, a system is provided. The system includes a beginning level language interpreter candidate module that provides, if a language interpreter candidate is a beginning level language interpreter candidate, a preliminary assessment and a language proficiency test. Further, the system includes an entry level language interpreter candidate module that provides, if the language interpreter has a predetermined amount of entry level language interpreter experience or has completed beginning level language interpreter requirements, an interpreter skills assessment test. In addition, the system includes a professional level interpreter candidate module that provides, if the language interpreter candidate has a predetermined amount of professional level language interpreter experience, a predetermined amount of training in a subject matter field associated with the subject matter skill set, or has passed the interpreter skills assessment test, a subject matter skill set language interpretation certification test by (i) providing a screening of a candidate on a prerequisite, (ii) providing a written examination to a qualified candidate, and (iii) providing an oral examination to the qualified candidate if the qualified candidate passes the written examination. The qualified candidate is a candidate that passes the screening. Finally, the system includes a certification module that provides certification to the qualified candidate if the qualified candidate passes both the written examination and the oral examination.

In another aspect of the disclosure, a computer program product is provided. The computer program product includes a computer useable medium having a computer readable program. The computer readable program when executed on a computer causes the computer to provide, if a language interpreter candidate is a beginning level language interpreter candidate, a preliminary assessment and a language proficiency test. Further, the computer is caused to provide, if the language interpreter has a predetermined amount of entry level language interpreter experience or has completed beginning level language interpreter requirements, an interpreter skills assessment test. In addition, the computer is caused to provide, if the language interpreter candidate has a predetermined amount of professional level language interpreter experience, a predetermined amount of training in a subject matter field associated with the subject matter skill set, or has passed the interpreter skills assessment test, a subject matter skill set language interpretation certification test by (i) providing a screening of a candidate on a prerequisite, (ii) providing a written examination to a qualified candidate, and (iii) providing an oral examination to the qualified candidate if the qualified candidate passes the written examination. The qualified candidate is a candidate that passes the screening. The computer is also caused to provide certification to the qualified candidate if the qualified candidate passes both the written examination and the oral examination.

In yet another aspect of the disclosure, a system is provided. The system may include a communication device based screening module that provides, through the communication device, a screening of a candidate on a prerequisite. Further, the system may include a communication device based written examination module that provides, through the communication device, a written examination that is provided to a qualified candidate. The qualified candidate is a candidate that passes the screening. In addition, the system may include an oral examination automated system that provides an oral examination to the qualified candidate if the qualified candidate passes the written examination. The system may also include an examination results delivery module that delivers examination results to the qualified candidate. Finally, the system may include a certification module that provides certification to the qualified candidate if the qualified candidate passes both the written examination and the oral examination.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a language interpreter development and certification process.

FIG. 2 illustrates the subcomponent process blocks of the process block for the preliminary assessment illustrated in FIG. 1.

FIG. 3 illustrates a subprocess between the process block illustrated in FIG. 1 that provides a Language Proficiency Test (“LPT”) and the process block illustrated in FIG. 1 that provides training in language interpreting fundamentals.

FIG. 4 illustrates a subprocess between the process block illustrated in FIG. 1 that provides a language interpreter skills assessment (“IST”) test, the process block that provides training in language interpretation for a subject matter skill set, and the process block that provides a subject matter skill set language interpretation certification test.

FIG. 5A illustrates a subprocess between the process block illustrated in FIG. 4 that provides a subject matter skill set language interpretation certification test, the process block illustrated in FIG. 1 that provides continuing education training, and the process block illustrated in FIG. 1 that provides renewals/maintenance of certification status.

FIG. 5B illustrates an example in which the language interpreter candidate may be provided with the IST at the process block, receive advanced subject matter skill set training at a process block, and receive on-the-job practice and mentoring at a process block before being provided with the subject matter skill set language interpreter certification test.

FIG. 5C illustrates a subprocess that is a variation of the subprocess illustrated in FIG. 5B in that the language interpreter candidate may only receive the advanced subject matter skill set training at the process block prior to being provided with the subject matter skill set language interpreter certification test at the subprocess block.

FIG. 6A illustrates a subprocess that may be utilized by a beginning language interpreter candidate to obtain certification.

FIG. 6B illustrates a subprocess that may be utilized by an entry level interpreter candidate to obtain certification.

FIG. 6C illustrates a subprocess that may be utilized by a professional level interpreter to obtain certification. The language interpreter candidate is provided with advanced subject matter skill set training at the process block, provided with a subject matter skill set language interpretation certification test, provided with a subject matter skill set certificate at the process block, allowed to be entered into a registry at the process block, provided with continuing education training at the process block, and provided renewal/maintenance of certification status at the process block.

FIG. 6D illustrates a subprocess that is a variation of the subprocess that may be utilized by a professional level interpreter to obtain certification.

FIG. 7 illustrates a process that may be utilized for development and certification.

FIG. 8 illustrates a block diagram of a station or system that provides language interpreter development and certification.

FIG. 9 illustrates a subprocess for the process block illustrated in FIG. 1 for the subject matter skill set language interpretation certification test.

FIG. 10 illustrates a system that may be utilized to provide any of the web-based services provided for in the disclosure.

### DETAILED DESCRIPTION

A method and apparatus is provided for language interpreter development and certification. Accordingly, language interpreters have a standardized program that allows them to obtain certification if certain criteria are met, or determine which skills need to be further developed in order to obtain certification. The terms qualification and validation may also be utilized interchangeably with the term certification herein. Language interpretation customers benefit by knowing that the language interpreter of choice has met a standardized set of criteria that is applicable to language interpreters. Further, in one embodiment, the criteria may be specifically tailored to the subject matter skill set of the language interpretation customer, e.g., medical, financial, legal, insurance, etc., such that the language interpretation customer can obtain a certified language interpreter for the particular subject matter skill set.

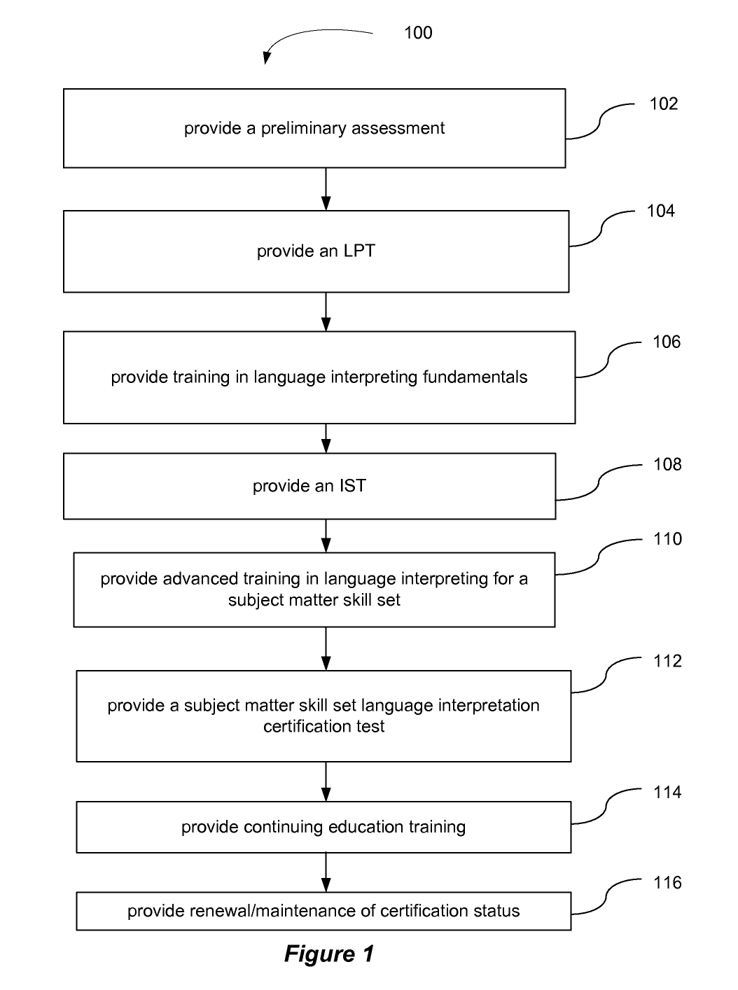

FIG. 1 illustrates a language interpreter development and certification process 100. The language interpreter development and certification process 100 is the overall process that includes a number of process components. An overview of each of these components is provided in FIG. 1, and a more detailed discussion of each of these process components is provided in the subsequent figures.

At a process block 102, the language interpreter development and certification process 100 provides a preliminary assessment. The terms pre-qualification and pre-validation may also be utilized interchangeably with the term preliminary assessment herein. In one embodiment, the preliminary assessment is a self-assessment. In another embodiment, the preliminary assessment is conducted by an entity. The entity may be a language interpreter service provider, a language interpreter testing provider, a language assessment provider, a language teaching institution, a trade association such as a language interpreter association, etc. The entity may also be a non-language interpreter provider such as a trade association that is not involved in language interpretation. Accordingly, the preliminary assessment can be industry specific. Alternatively, the language interpreter testing provider may provide the preliminary assessment in addition to the language interpreter certification program. In another embodiment, the preliminary assessment may be a combination of a self-assessment and an assessment conducted by one or more entities. For example, the preliminary assessment may include a test taken by the individual candidate and a test provided by an entity. The preliminary assessment can include a web-based written test, a live written test, an oral test, or any combination thereof. For the web based version, the preliminary assessment can be delivered through a web site. The language interpreter can then take the preliminary assessment through the web site. In yet another embodiment, the preliminary assessment is optional. Further, at a process block 104, the language interpreter development and certification process 100 provides an LPT in either one or both of the language pair of the language interpreter. For example, a language interpreter with a language pair of Spanish and English can be tested in either Spanish or English, or can be tested in both Spanish and English. In addition, at a process block 106, the language interpreter development and certification process 100 provides training in language interpreting fundamentals. At a process block 108, the language interpreter development and certification process 100 also provides an IST.

In one embodiment, the IST is bidirectional such that the language interpreter is tested to interpret from and into each language of the language pair. For example, an IST may have a language interpreter with a language pair of Spanish and English interpret from Spanish into English and from English into Spanish. Further, at a process block 110 the language interpreter development and certification process 100 provides training in language interpreting for a subject matter skill set. For example, advanced training may be provided. In addition, at a process block 112, the language interpreter development and certification process 100 provides a subject matter skill set language interpretation certification test. At a process block 114, the language interpreter development and certification process 100 provides continuing education training. Finally, at a process block 116, the language interpreter development and certification process 100 provides renewals/maintenance of certification status. Recertification is a term that may be utilized for renewal/maintenance of certification status.

The development and certification process 100 is intended to be customizable to the specific level of the language interpreter candidate throughout his or her language interpreter career. For example, a beginning level language interpreter candidate that would like to obtain beginning through advanced certifications may undergo the entire interpreter development and certification process 100. The beginning level language interpreter candidate is defined herein as a language interpreter candidate with little or no language interpreting experience. However, a beginning language interpreter candidate that intends only to obtain an intermediate certification may not undergo the advanced components of the development and certification process 100. Further, a language interpreter candidate that is already an intermediate level language interpreter would not necessarily need to undergo the beginning components of the development and certification process 100.

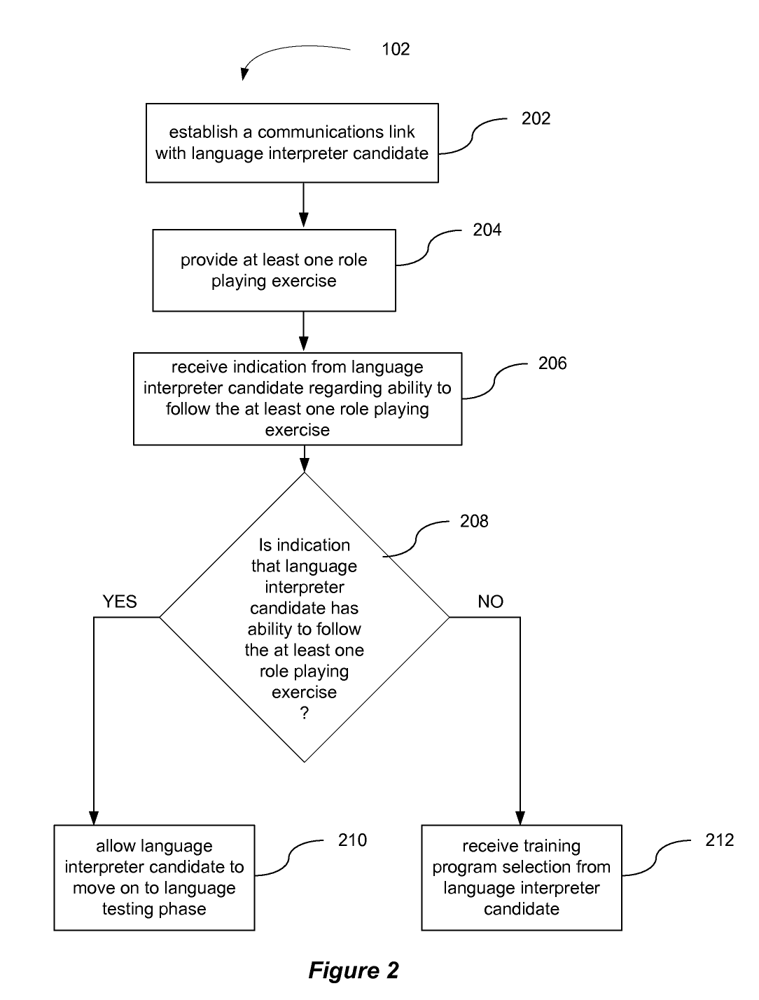

FIG. 2 illustrates the subcomponent process blocks of the process block 102 for the preliminary assessment illustrated in FIG. 1. The preliminary assessment determines whether a language interpreter is prepared to enter the language testing phase of the language interpreter development and certification process 100 illustrated in FIG. 1 or would like to first obtain training. Accordingly, the language interpreter is provided with an opportunity to develop certain skills prior to being tested for the certification.

At a subcomponent process block 202, a communications link with the language interpreter candidate is established. The language interpreter candidate may utilize a land line phone, cell phone, personal digital assistant (“PDA”), personal media player (“PMP”), or the like to make the telephone call. In one embodiment, an ‘800’ telephone number may be utilized. In another embodiment, the telephone call may be placed through a Voice Over IP (“VOIP”) or other Internet connection. In yet another embodiment, the communication may be in a format other than that of a telephone call. For example, the communication may be through an e-mail program, instant messaging program, or text message program. The communication may alternatively be in-person. In another embodiment, the communication may be in a written format. In other words, the role playing may be a written exercise that the language interpreter candidate participates in by filling out a document that is submitted in person, by mail, e-mail, or by fax. The preliminary assessment may also be provided through an automated system. Alternatively, the self assessment can be performed through a web site. For example, the language interpreter candidate may perform the at least one role playing exercise, which will be described, through the web site.

Further, at a subcomponent process block 204, at least one role playing exercise is provided to the language interpreter candidate. More than one role playing exercise may be utilized. The role playing exercise allows the language interpreter candidate to participate in a specific role. That specific role may correspond to the field for the subject matter skill set that the language interpreter is seeking language interpreter certification. For example, a language interpreter interested in seeking certification in the medical field may be asked to play the role of a medical assistant during a medical procedure. In one embodiment, the language interpreter is asked to provide the subject matter skill set of interest so that a certification system can select at least one corresponding role playing exercise.

In one configuration, the role playing exercise involves a single role. In other words, the language interpreter candidate may be asked by an automated system or by a live person during the telephone call or other communication to act out a role by himself or herself. In another configuration, the role playing exercise is interactive with multiple roles. In other words, the language interpreter candidate has one role and the automated system or live person on the telephone call or other communication may have another role. The different parties then act out their respective roles. The language interpreter candidate and the other party can switch between roles so that the language interpreter candidate is able to role play in different roles. For example, the language interpreter candidate may in one instance play the role of a doctor and the other party the role of the patient, and in another instance the language interpreter candidate may play the role of the patient and the other party the role of the doctor. Those different instances may be part of the same telephone call or other communication.

The language interpreter makes a self assessment based on the role playing as to whether he or she was able to follow along with the role playing. Accordingly, at a subcomponent process block 206, an indication is received from the language interpreter candidate as to whether the language interpreter candidate was able to follow along with the role playing. The indication may be provided by the interpreter candidate providing an input through the keypad on his or her communication device. Alternatively, the language interpreter candidate may provide an oral indication to an automated system or to a live tester. The language interpreter candidate may also provide the indication through an e-mail, instant message, or text message. Further, the interpreter candidate may provide the indication through a written format through mail, e-mail, or fax. In an alternative embodiment, the assessment is not a self assessment, but rather a computer generated assessment of the language interpreter candidate's basic ability of follow along with the at least one role playing exercise.

At a subcomponent decision block 208, a determination is made as whether the indication was that the language interpreter candidate was able to follow the at least one role playing exercise or was not able to follow the at least one role playing exercise. If the indication was that the language interpreter candidate was able to follow the at least one role playing exercise, a move is made to a subcomponent process block 210 to allow the language interpreter candidate to move on to the language testing phase. However, if the indication was that the language interpreter candidate was not able to follow the at least one role playing exercise, a move is made to a subcomponent process block 212 to receive a training program selection from the language interpreter candidate. Accordingly, the language interpreter candidate is given the opportunity to refine certain skills prior to moving forward into the testing phase. In one embodiment, the language interpreter can receive the specific training and then repeat the subcomponent process blocks of the process block 102 with the same or different at least one role playing exercise. In another embodiment, the language interpreter can move directly into the language testing phase after completion of the specific training without repeating the same or different at least one role playing exercise.

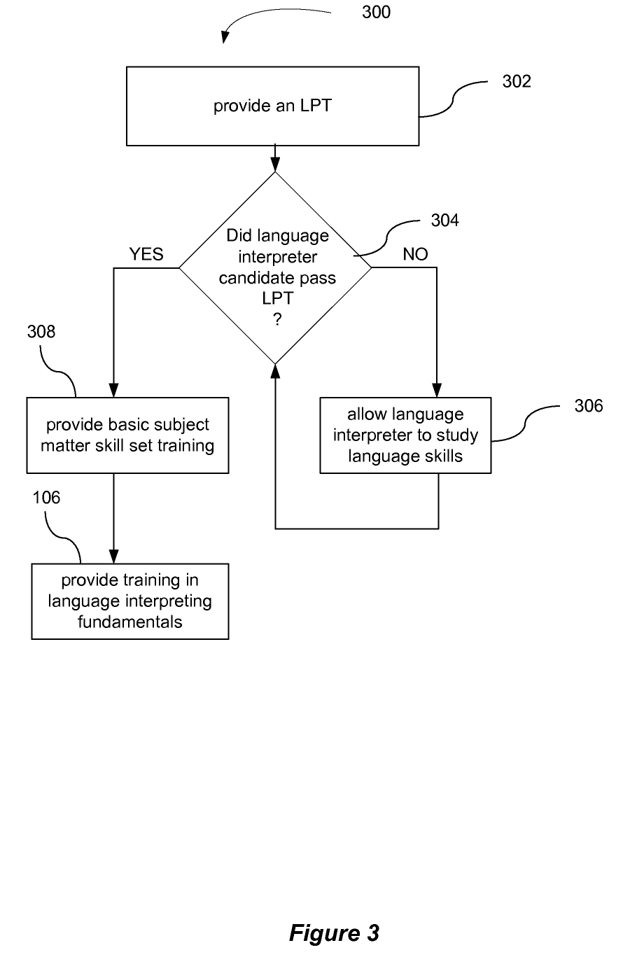

FIGS. 3-5 illustrate different types certifications that may be obtained in the development and certification process 100.

FIG. 3 illustrates a subprocess 300 between the process block 104 illustrated in FIG. 1 that provides an LPT and the process block 106 illustrated in FIG. 1 that provides training in language interpreting fundamentals. The subprocess 300 is the first level towards language interpreter certification. For example, the subprocess 300 may be bilingual language proficiency. At a subprocess block 302, the subprocess 300 provides a first level LPT. Further, at a decision block 304, a determination is made as to whether the language interpreter candidate passed the LPT. If the language interpreter candidate does not pass the LPT, the subprocess 300 moves to a subprocess block 306 to allow the language interpreter candidate to study language skills. The subprocess 300 then moves back to the decision block 304 and iterates through the process block 306 until the language interpreter candidate passes the LPT. If the language interpreter candidate passes the LPT, irrespective of whether the subprocess 300 had moved to the subprocess block 306, the subprocess 300 moves to a subprocess block 308. At the subprocess block 308, the subprocess 300 provides basic subject matter skill set training. For example, training in basic medical field knowledge may be provided to a language interpreter candidate in the medical field. In an alternative embodiment, the subprocess 300 may additionally provide customer service skills and professionalism training. Finally, the subprocess 300 moves to the process block 106 illustrated in FIG. 1 that provides training in language interpreting fundamentals.

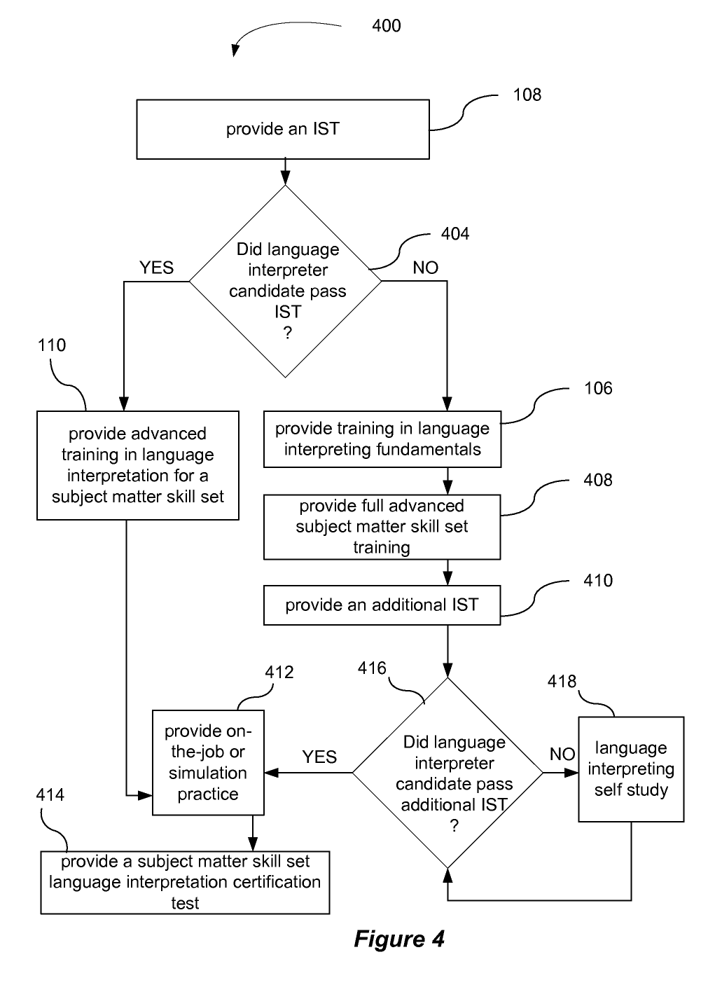

FIG. 4 illustrates a subprocess 400 between the process block 108 illustrated in FIG. 1 that provides an IST, the process block 110 that provides training in language interpretation for a subject matter skill set, and the process block 112 that provides a subject matter skill set language interpretation certification test. The subprocess 400 basically provides a certification for an entry level language interpreter. In other words, the subprocess 400 is the second level towards language interpreter certification. The entry level language interpreter is defined herein to be a language interpreter candidate that has some language interpreting experience. The entry level language interpreter may have reached that level by moving through each of the process components of the language interpreter development and certification process 100 prior to the process block 108 or may have achieved that level in another fashion. At a subprocess block 108, the subprocess 400 provides an IST. Further, at a decision block 404, a determination is made as to whether the language interpreter candidate passed the IST. If the language interpreter candidate passes the IST, the subprocess 400 moves to a subprocess block 110 to provide intensive skill set training. For example, the subprocess 400 may provide advanced medical language training. In other words, the language interpreter may receive training in specific language terms associated with a specific subject matter skill set such as the medical field. The subprocess 400 then moves to a subprocess block 412 to provide on-the-job or simulation practice. Further, the subprocess 400 then moves to a subprocess block 414 to provide a subject matter skill set language interpretation certification test. For example, a medical certification test in a given language pair may be provided.

At the decision block 404, if the language interpreter candidate did not pass the IST, the subprocess 400 moves to the process block 106 to provide training in language interpreting fundamentals. The subprocess 400 then moves to a subprocess bock 408 provide full advanced subject matter skill set training. In one configuration, the time period for full advanced subject matter skill set training may be forty hours. Other time periods may be utilized. In one configuration, the subprocess block 408 is an optional component of the subprocess 400. For example, full advanced medical training may be provided in a given language. In addition, the subprocess 400 then moves to a subprocess block 410 to provide an additional IST. Further, the subprocess 400 moves to a decision block 416 to determine if the language interpreter candidate passed the additional IST. If the language interpreter candidate passes the additional IST, the subprocess 400 moves to the subprocess block 412 to provide the on-the-job or simulation practice, and then to the subprocess block 414 to provide the subject matter skill set language interpretation certification test. If, at the decision block 416, the language interpreter candidate did not pass the additional IST, the subprocess 400 moves to a process block 418 so that the language interpreter candidate may perform language interpreting self study to attempt taking an additional IST again.

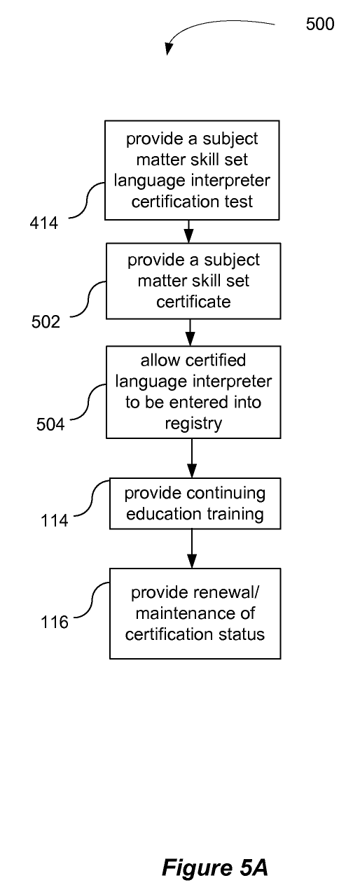

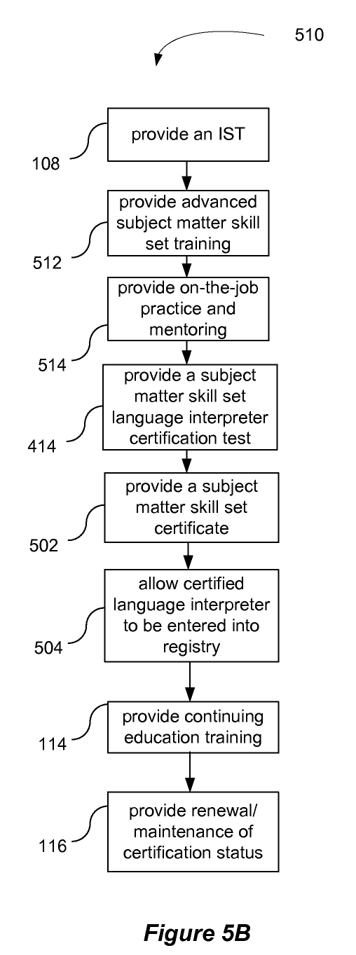

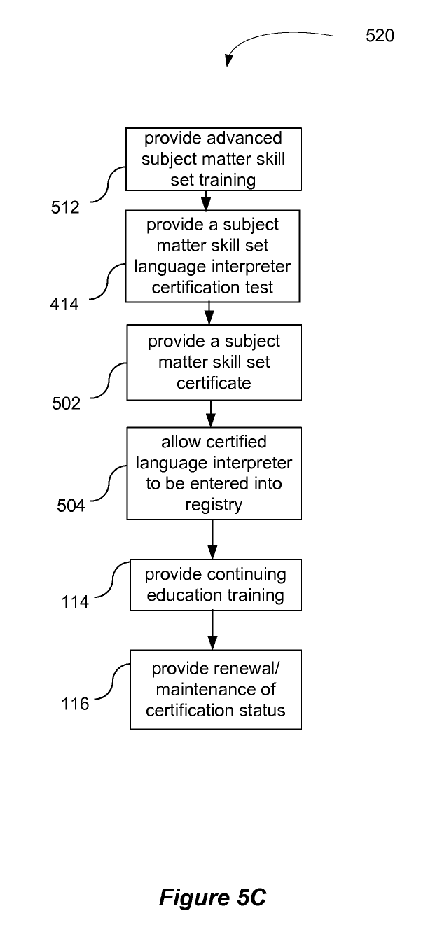

FIG. 5A illustrates a subprocess 500 between the process block 414 illustrated in FIG. 4 that provides a subject matter skill set language interpretation certification test, the process block 114 illustrated in FIG. 1 that provides continuing education training, and the process block 116 illustrated in FIG. 1 that provides renewals/maintenance of certification status. The subprocess 500 basically provides a certification for a professional level language interpreter. The professional level language interpreter is defined herein as a language interpreter that has a substantial amount of language interpreting experience. In other words, the subprocess 500 is the third level towards language interpreter certification. The professional level language interpreter may have reached that level by moving through each of the process components of the language interpreter development and certification process 100 prior to the process block 414 or may have achieved that level in another fashion. At the process block 414, the subprocess 500 provides the subject matter skill set language interpreter certification test. If the language interpreter candidate passes the subject matter skill set language interpreter certification, the subprocess 500 moves on to the subprocess block 502 to provide a subject matter skill set certificate. Further, the subprocess 500 moves on to the subprocess block 504 to allow the certified language interpreter to be entered into a registry. The registry may be local, state, national, or international. For example, a certified medical interpreter may be allowed to enter a National Medical Certified Interpreter Registry. In addition, at the block 114, the subprocess 500 provides continuing education training. In another embodiment, the subprocess 500 may not provide the continuing education training, but may allow another process or subprocess to provide the continuing education training. Finally, at the process block 116, the subprocess 500 provides renewal/maintenance of certification status.

In the subprocess 500, the language interpreter candidate may take other tests and/or receive additional training prior to being provided with the subject matter skill set language interpreter certification test at the subprocess block 414. FIG. 5B illustrates an example subprocess 510 in which the language interpreter candidate may be provided with the IST at the process block 108, receive advanced subject matter skill set training at a process block 512, and receive on-the-job practice and mentoring at a process block 514 before being provided with the subject matter skill set language interpreter certification test. In one configuration, the process block 514 is an optional component of the subprocess 510. Alternatively, FIG. 5C illustrates a subprocess 520 that is a variation of the subprocess 510 illustrated in FIG. 5B in that the language interpreter candidate may only receive the advanced subject matter skill set training at the process block 512 prior to being provided with the subject matter skill set language interpreter certification test at the subprocess block 414.

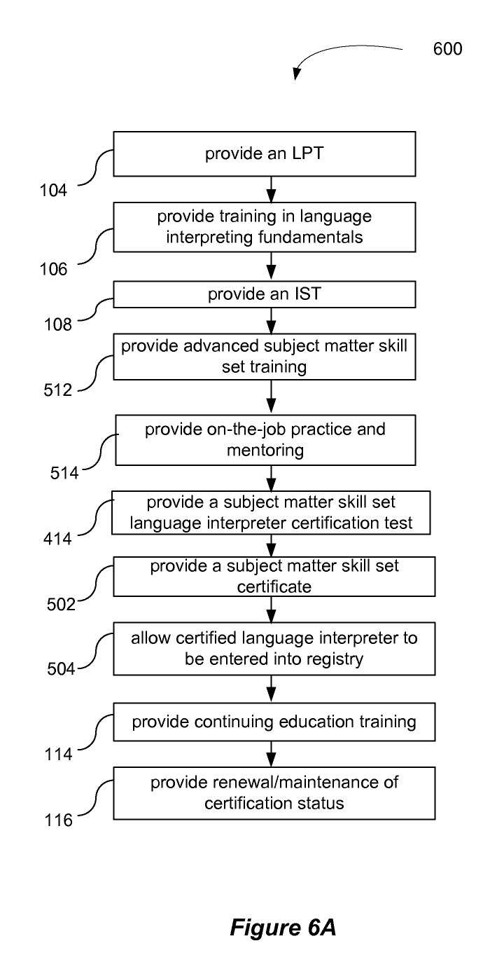

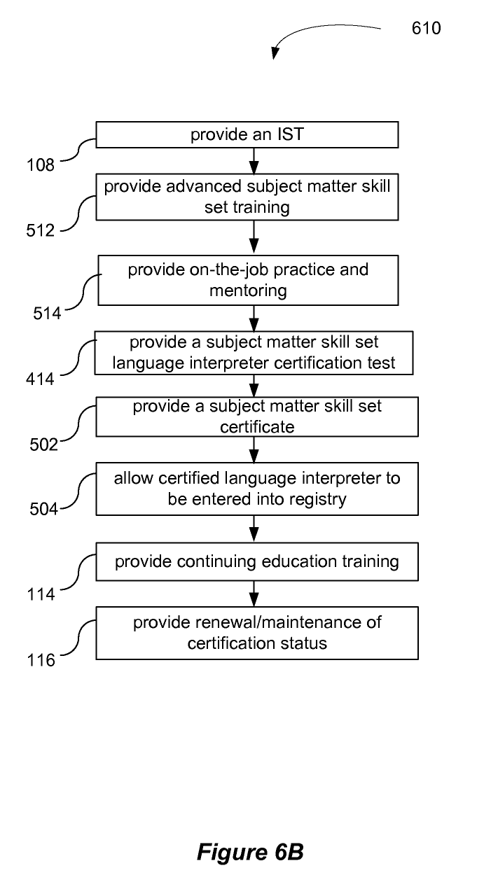

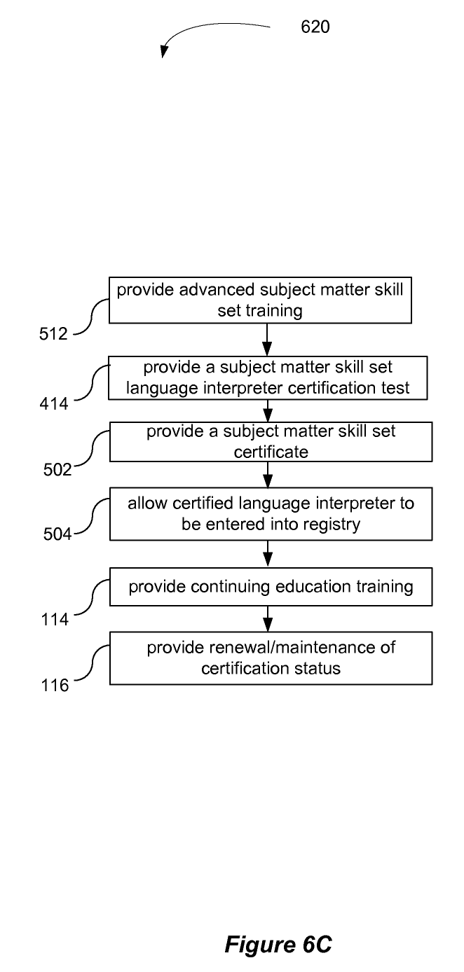

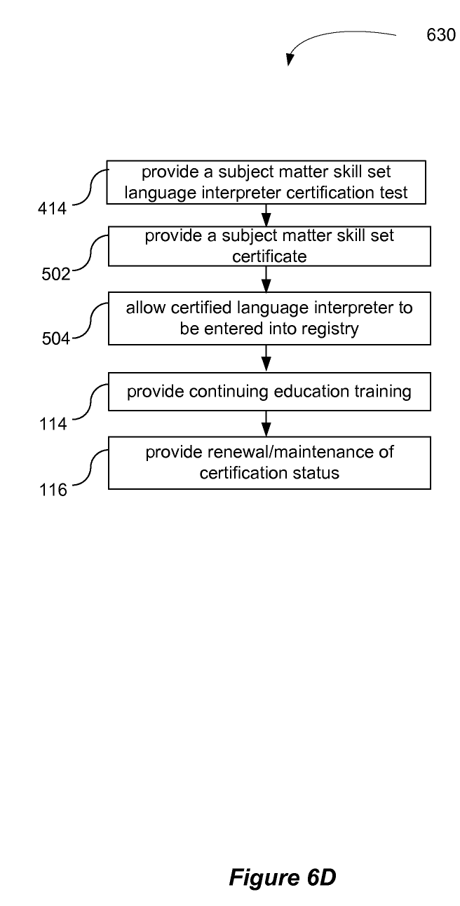

FIGS. 6A through 6D provides examples of subprocess that may be utilized to obtain language interpreter certification. FIG. 6A illustrates a subprocess 600 that may be utilized by a beginning language interpreter candidate to obtain certification. The language interpreter candidate is provided with an LPT at the process block 104, provided with training in language interpreting fundamentals at the process block 106, provided with an IST at the process block 108, provided with advanced subject matter skill set training at the process block 512, provided with on-the-job practice and mentoring at the process block 514, provided with a subject matter skill set language interpretation certification test, provided with a subject matter skill set certificate at the process block 502, allowed to be entered into a registry at the process block 504, provided with continuing education training at the process block 114, and provided renewal/maintenance of certification status at the process block 116. In one configuration, the process block 514 is an optional component of the subprocess 600. FIG. 6B illustrates a subprocess 610 that may be utilized by an entry level interpreter candidate to obtain certification. The language interpreter candidate is provided with an IST at the process block 108, provided with advanced subject matter skill set training at the process block 512, provided with on-the-job practice and mentoring at the process block 514, provided with a subject matter skill set language interpretation certification test, provided with a subject matter skill set certificate at the process block 502, allowed to be entered into a registry at the process block 504, provided with continuing education training at the process block 114, and provided renewal/maintenance of certification status at the process block 116. FIG. 6C illustrates a subprocess 620 that may be utilized by a professional level interpreter to obtain certification. The language interpreter candidate is provided with advanced subject matter skill set training at the process block 512, provided with a subject matter skill set language interpretation certification test, provided with a subject matter skill set certificate at the process block 502, allowed to be entered into a registry at the process block 504, provided with continuing education training at the process block 114, and provided renewal/maintenance of certification status at the process block 116. FIG. 6D illustrates a subprocess 630 that is a variation of the subprocess 620 that may be utilized by a professional level interpreter to obtain certification. The language interpreter candidate is provided with a subject matter skill set language interpretation certification test, provided with a subject matter skill set certificate at the process block 502, allowed to be entered into a registry at the process block 504, provided with continuing education training at the process block 114, and provided renewal/maintenance of certification status at the process block 116.

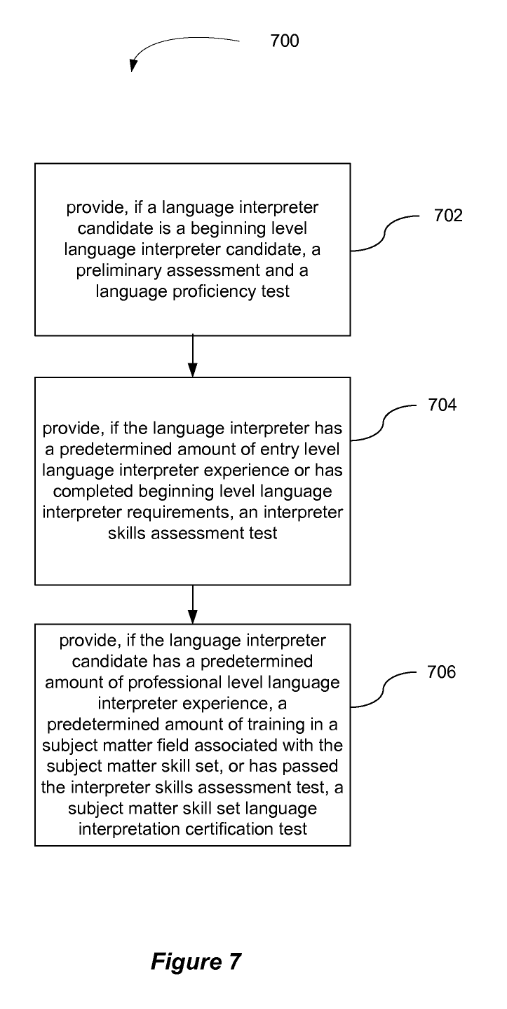

FIG. 7 illustrates a process 700 that may be utilized for development and certification. At a process block 702, the process provides, if a language interpreter candidate is a beginning level language interpreter candidate, a preliminary assessment and a language proficiency test. Further, at a process block 704, the process 700 provides, if the language interpreter has a predetermined amount of entry level language interpreter experience or has completed beginning level language interpreter requirements, an interpreter skills assessment test. In addition, at a process block 706, the process 700 provides, if the language interpreter candidate has a predetermined amount of professional level language interpreter experience, a predetermined amount of training in a subject matter field associated with the subject matter skill set, or has passed the interpreter skills assessment test, a subject matter skill set language interpretation certification test. In one embodiment, the process 700 further provides certification in the subject matter field to the language interpreter candidate and a certificate of the certification to the language interpreter candidate upon the language interpreter candidate passing the subject matter skill set language interpretation certification test.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network.

A computer is herein intended to include any device that has a general, multi-purpose or single purpose processor as described above. For example, a computer may be a set top box (“STB”), cell phone, portable media player, or the like.

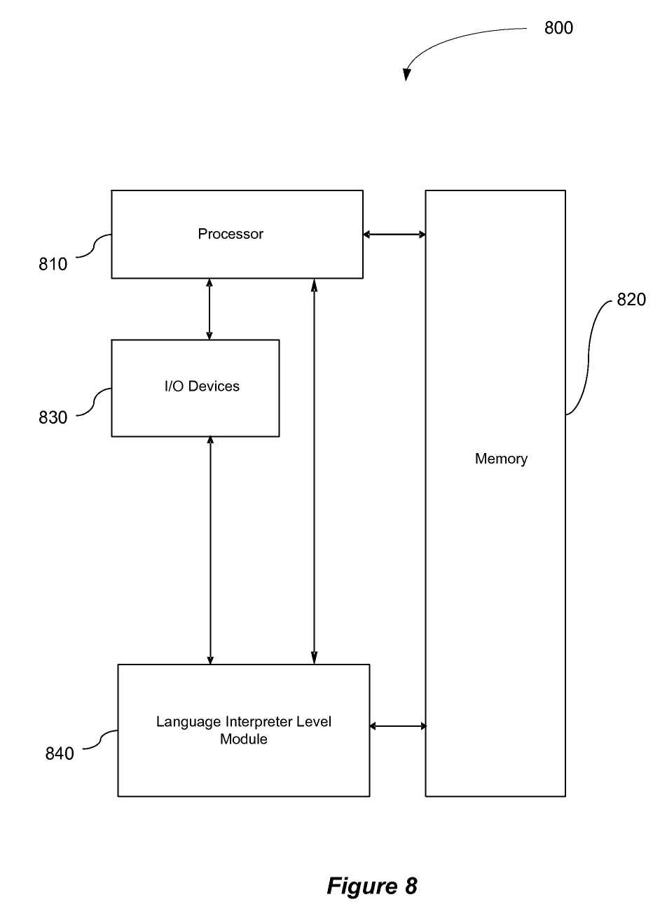

FIG. 8 illustrates a block diagram of a station or system 800 that provides language interpreter development and certification. In one embodiment, the station or system 800 is implemented utilizing a general purpose computer or any other hardware equivalents. Thus, the station or system 800 comprises a processor 810, a memory 820, e.g., random access memory (“RAM”) and/or read only memory (ROM), a language interpreter level module 840, and various input/output devices 830, (e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the language interpreter level module 840 may be implemented as one or more physical devices that are coupled to the processor 810. For example, the language interpreter level module may include a plurality of modules, e.g., a beginning level language interpreter module, an entry level language interpreter module, and a professional level language interpreter module, as a single component or each as separate components. Alternatively, the language interpreter level module 840 may be represented by one or more software applications (or even a combination of software and hardware, e.g., using application specific integrated circuits (ASIC)), where the software is loaded from a storage medium, (e.g., a magnetic or optical drive, diskette, or non-volatile memory) and operated by the processor in the memory 820 of the computer. As such, the language interpreter level module 840 (including associated data structures) of the present disclosure may be stored on a computer readable medium, e.g., RAM memory, magnetic or optical drive or diskette and the like.

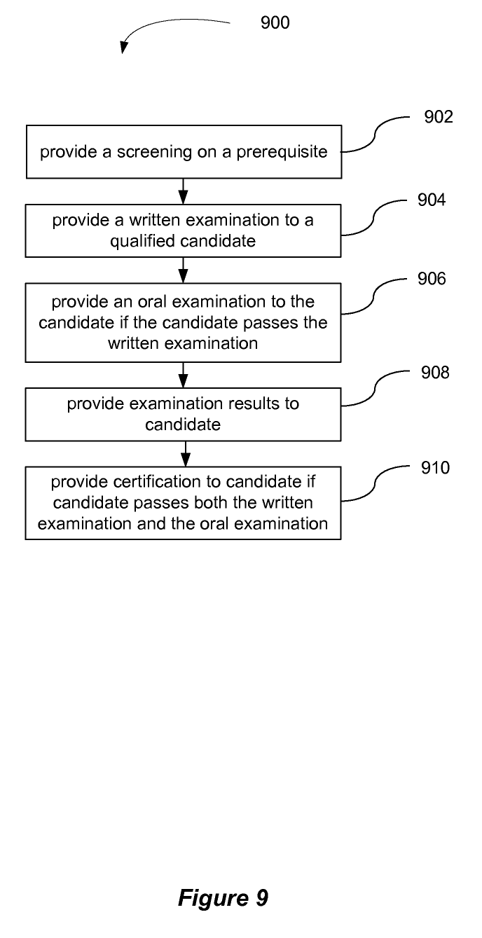

FIG. 9 illustrates a subprocess 900 for the process block 112 illustrated in FIG. 1 for the subject matter skill set language interpretation certification test. The subprocess 900 provides subcomponents of one configuration of the process block 112. At a subprocess process block 902, the subprocess 900 provides a screening on a prerequisite. The screening may be conducted orally, in writing, through the web, etc. In one embodiment, the prerequisite is a requirement that must be met. In one embodiment, the screening may be conducted through an automated phone system. The requirement may be skills based, non-skills based, or both. Further, at a subprocess block 904, the subprocess 900 provides a written examination to a qualified candidate. The candidate becomes qualified by being successfully screened by the prerequisite. In one embodiment, the written examination can be web-based. In other words, the written examination can be delivered through a web site. The language interpreter can then take the written examination through the web site. Further, the written examination may be rated by a web-based scoring instrument. In an alternative embodiment, the written examination can be implemented in written form without the Internet. In one embodiment, the written test is language specific. In addition, at a subprocess block 906, the subprocess 900 provides an oral examination to the candidate if the candidate passes the written examination. The sight translation test is a test that is utilized to assess an interpreter's ability to read, comprehend, and interpret a written document into another language. For example, the interpreter may be provided with some written material, e.g., a half page to a full page, to briefly review the information and then interpret the contents into another language. In one configuration, the sight translation test is unidirectional such that the translation is from one language into another language, e.g., English into Spanish. In another configuration, the sight translation test is bidirectional such that the translation is from a first language into a second language and from a second language into a first language, e.g., English into Spanish and Spanish into English. In another embodiment, the oral examination includes a consecutive interpreting test. In yet another embodiment, the oral examination includes both a sight translation test and a consecutive interpreting test. In one embodiment, the consecutive interpreting test is a bidirectional oral consecutive examination. In other words, the interpreter waits for the speaker to stop speaking before interpreting rather than interpreting simultaneously as the speaker is speaking and provides interpretation from a first language to a second language and from the second language into the first language. In another embodiment, the consecutive interpreting test is a unidirectional oral consecutive examination. In other words, the interpreter waits for the speaker to stop speaking before interpreting rather than interpreting simultaneously as the speaker is speaking and only provides interpretation from a first language to a second language. In one embodiment, the oral examination includes a sight translation test. The oral examination may be delivered to the qualified candidate by a live tester, an automated in-person system, an automated phone system, a web server, or the like. In one embodiment, the automated system may also record responses for scoring.

In one embodiment, both the written examination and the oral examination may be proctored at the same location such as a testing site, a customer location, etc. In another embodiment, the written examination and the oral examination may be proctored at different locations. In one embodiment, the manager of a customer location proctors the written examination and/or the oral examination.

In addition, at a subprocess block 908, the subprocess 900 provides examination results to the candidate. At a subprocess block 910, the subprocess 900 provides certification to the candidate if the candidate passes both the written examination and the oral examination. For example, in the medical field, a Certified Medical Interpreter (“CMI”) will be issued to candidates that pass both the written examination and the oral examination. In one embodiment, a certificate is provided to the candidate as an indication of the certification. In another embodiment, a certificate is not provided to the candidate even though the candidate has been certified. Providing the certificate is an optional approach to providing an indication of certification.

Other subprocesses may be utilized. For example, a subset of the subprocess blocks illustrated in FIG. 9 may be utilized.

All the components of the subprocess 900 may be performed by a single entity such as a language interpreter service provider. Alternatively, different components of the subprocess 900 may be performed by different entities. For example, the oral examination may be performed by a language interpreter service provider and the written portion may be prepared by a language interpreter testing provider.

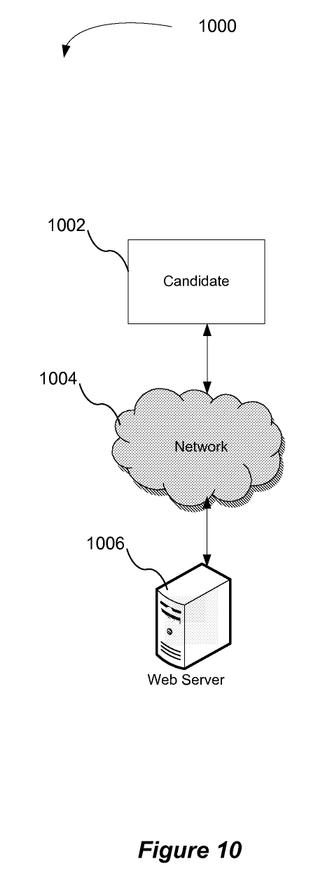

FIG. 10 illustrates a system 1000 that may be utilized to provide any of the web-based services provided for in the disclosure. In one embodiment, an entity can provide a service from a web server 1006 through a network 1004 to a candidate 1002 for certification. The service can be the screening of the candidate on a prerequisite, the written examination that is provided to a qualified candidate, or any of the other components of the certification processes, systems, and devices described herein. The network 1004 may be a local area network (“LAN”), wide area network (“WAN”), and/or the Internet.

In one embodiment, a system that implements any of the configurations described herein may utilize a communication device. An example of a communication device is a web-based server, an automated telephone system, or the like. The system may include a communication device based screening module that provides, through the communication device, a screening of a candidate on a prerequisite. Further, the system may include a communication device based written examination module that provides, through the communication device, a written examination that is provided to a qualified candidate. The qualified candidate is a candidate that passes the screening. In addition, the system may include an oral examination automated system that provides an oral examination to the qualified candidate if the qualified candidate passes the written examination. The system may also include an examination results delivery module that delivers examination results to the qualified candidate. Finally, the system may include a certification module that provides certification to the qualified candidate if the qualified candidate passes both the written examination and the oral examination.

Training programs may take place before each of the assessment stages. A candidate may bypass some of the assessment programs if the candidate is deemed experienced and highly qualified.

It is understood that the processes and systems described herein may also be applied in other types of processes and systems. Those skilled in the art will appreciate that the various adaptations and modifications of the embodiments of the processes and systems described herein may be configured without departing from the scope and spirit of the present processes and systems. Therefore, it is to be understood that, within the scope of the appended claims, the present processes and systems may be practiced other than as specifically described herein.

We claim:

1. A method comprising:
providing a screening of a candidate on a prerequisite;
providing a written examination to a qualified candidate, the qualified candidate passing the screening;
providing an oral examination to the qualified candidate if the qualified candidate passes the written examination;
providing examination results to the qualified candidate; and
providing certification to the qualified candidate if the qualified candidate passes both the written examination and the oral examination.

2. The method of claim 1, wherein the screening is oral.

3. The method of claim 1, wherein the screening is written.

4. The method of claim 1, wherein the screening is telephonic.

5. The method of claim 1, wherein the screening is web-based.

6. The method of claim 1, wherein the written examination is web-based.

7. The method of claim 6, wherein the written examination is rated by a web-based scoring instrument.

8. The method of claim 1, wherein the oral examination includes a sight translation test that tests an ability of the qualified candidate to read, comprehend, and interpret a written document into another language.

9. The method of claim 1, wherein the oral examination includes a consecutive interpreting test.

10. The method of claim 1, wherein the oral examination includes (i) a sight translation test that tests an ability of the qualified candidate to read, comprehend, and interpret a written document into another language and (ii) a consecutive interpreting test.

11. The method of claim 1, wherein the oral examination is provided through a live tester.

12. The method of claim 1, wherein the oral examination is provided through an automated system.

13. The method of claim 1, wherein the written examination is proctored at a testing site.

14. The method of claim 1, wherein the written examination is proctored by a manager at a customer location.

15. The method of claim 1, wherein the oral examination is proctored at a testing site.

16. The method of claim 1, wherein the oral examination is proctored by a manager at a customer location.

17. The method of claim 1, wherein the prerequisite is a requirement that has to be met.

18. A system comprising:
a web-based screening module that provides, through a web server, a screening of a candidate on a prerequisite;
a web-based written examination module that provides, through the web server, a written examination that is provided to a qualified candidate, the qualified candidate passing the screening;
an oral examination automated system that provides an oral examination to the qualified candidate if the qualified candidate passes the written examination;
an examination results delivery module that delivers examination results to the qualified candidate; and
a certification module that provides certification to the qualified candidate if the qualified candidate passes both the written examination and the oral examination.

19. The system of claim 18, wherein the screening is oral.

20. The system of claim 18, wherein the screening is written.

21. The system of claim 18, wherein the screening is telephonic.

22. The system of claim 18, further comprising a web-based scoring instrument that rates the written examination.

23. The system of claim 18, wherein the oral examination includes a sight translation test that tests an ability of the qualified candidate to read, comprehend, and interpret a written document into another language.

24. The system of claim 18, wherein the oral examination includes a consecutive interpreting test.

25. The system of claim 18, wherein the oral examination includes (i) a sight translation test that tests an ability of the qualified candidate to read, comprehend, and interpret a written document into another language and (ii) a consecutive interpreting test.

26. The system of claim 18, wherein the prerequisite is a requirement that has to be met.

27. A computer program product comprising a computer useable medium having a computer readable program, wherein the computer readable program when executed on a computer causes the computer to:
provide a screening of a candidate on a prerequisite;
provide a written examination to a qualified candidate, the qualified candidate passing the screening;
provide an oral examination to the qualified candidate if the qualified candidate passes the written examination;
provide examination results to the qualified candidate; and
provide certification to the qualified candidate if the qualified candidate passes both the written examination and the oral examination.

28. The computer program product of claim 27, wherein the screening is oral.

29. The computer program product of claim 27, wherein the screening is written.

30. The computer program product of claim 27, wherein the screening is telephonic.

31. The computer program product of claim 27, wherein the screening is web-based.

32. The computer program product of claim 27, wherein the written examination is web-based.

33. The computer program product of claim 32, wherein the written examination is rated by a web-based scoring instrument.

34. The computer program product of claim 27, wherein the oral examination includes a sight translation test that tests an ability of the qualified candidate to read, comprehend, and interpret a written document into another language.

35. The computer program product of claim 27, wherein the oral examination includes a consecutive interpreting test.

36. The computer program product of claim 27, wherein the oral examination includes (i) a sight translation test that tests an ability of the qualified candidate to read, comprehend, and interpret a written document into another language and (ii) a consecutive interpreting test.

37. The computer program product of claim 27, wherein the oral examination is provided through a live tester.

38. The computer program product of claim 27, wherein the oral examination is provided through an automated system.

39. The computer program product of claim 27, wherein the written examination is proctored at a testing site.

40. The computer program product of claim 27, wherein the written examination is proctored by a manager at a customer location.

41. The computer program product of claim 27, wherein the oral examination is proctored at a testing site.

42. The computer program product of claim 27, wherein the oral examination is proctored by a manager at a customer location.

43. The computer program product of claim 27, wherein the prerequisite is a requirement that has to be met.

44. A method comprising:
providing, if a language interpreter candidate is a beginning level language interpreter candidate, a preliminary assessment and a language proficiency test;
providing, if the language interpreter has a predetermined amount of entry level language interpreter experience or has completed beginning level language interpreter requirements, an interpreter skills assessment test;
providing, if the language interpreter candidate has a predetermined amount of professional level language interpreter experience, a predetermined amount of training in a subject matter field associated with the subject matter skill set, or has passed the interpreter skills assessment test, a subject matter skill set language interpretation certification test by (i) providing a screening of a candidate on a prerequisite, (ii) providing a written examination to a qualified candidate, the qualified candidate passing the screening, and (iii) providing an oral examination to the qualified candidate if the qualified candidate passes the written examination; and
providing certification to the qualified candidate if the qualified candidate passes both the written examination and the oral examination.

45. The method of claim 44, wherein the preliminary assessment is, at least in part, a self-assessment.

46. The method of claim 45, wherein the preliminary assessment is web-based.

47. The method of claim 45, wherein the preliminary assessment is oral.

48. The method of claim 45, wherein the preliminary assessment is written.

49. The method of claim 45, wherein the preliminary assessment is live.

50. The method of claim 44, wherein the screening is oral.

51. The method of claim 44, wherein the screening is written.

52. The method of claim 44, wherein the screening is telephonic.

53. The method of claim 44, wherein the screening is web-based.

54. The method of claim 44, wherein the written examination is web-based.

55. The method of claim 54, wherein the written examination is rated by a web-based scoring instrument.

56. The method of claim 44, wherein the oral examination includes a sight translation test that tests an ability of the qualified candidate to read, comprehend, and interpret a written document into another language.

57. The method of claim 44, wherein the oral examination includes a consecutive interpreting test.

58. The method of claim 44, wherein the oral examination includes (i) a sight translation test that tests an ability of the qualified candidate to read, comprehend, and interpret a written document into another language and (ii) a consecutive interpreting test.

59. The method of claim 44, wherein the oral examination is provided through a live tester.

60. The method of claim 44, wherein the oral examination is provided through an automated system.

61. The method of claim 44, wherein the written examination is proctored at a testing site.

62. The method of claim 44, wherein the written examination is proctored by a manager at a customer location.

63. The method of claim 44, wherein the oral examination is proctored at a testing site.

64. The method of claim 44, wherein the oral examination is proctored by a manager at a customer location.

65. The method of claim 44, wherein the prerequisite is a requirement that has to be met.

66. A system comprising:
a beginning level language interpreter candidate module that provides, if a language interpreter candidate is a beginning level language interpreter candidate, a preliminary assessment and a language proficiency test;
an entry level language interpreter candidate module that provides, if the language interpreter has a predetermined amount of entry level language interpreter experience or has completed beginning level language interpreter requirements, an interpreter skills assessment test; and
a professional level interpreter candidate module that provides, if the language interpreter candidate has a predetermined amount of professional level language interpreter experience, a predetermined amount of training in a subject matter field associated with the subject matter skill set, or has passed the interpreter skills assessment test, a subject matter skill set language interpretation certification test by (i) providing a screening of a candidate on a prerequisite, (ii) providing a written examination to a qualified candidate, the qualified candidate passing the screening, and (iii) providing an oral examination to the qualified candidate if the qualified candidate passes the written examination; and
a certification module that provides certification to the qualified candidate if the qualified candidate passes both the written examination and the oral examination.

67. The system of claim 66, wherein the preliminary assessment is, at least in part, a self-assessment.

68. The system of claim 67, wherein the preliminary assessment is web-based.

69. The system of claim 67, wherein the preliminary assessment is oral.

70. The system of claim 67, wherein the preliminary assessment is written.

71. The system of claim 67, wherein the preliminary assessment is live.

72. The system of claim 66, wherein the screening is oral.

73. The system of claim 66, wherein the screening is written.

74. The system of claim 66, wherein the screening is telephonic.

75. The system of claim 66, wherein the screening is web-based.

76. The system of claim 66, wherein the written examination is web-based.

77. The system of claim 76, wherein the written examination is rated by a web-based scoring instrument.

78. The system of claim 66, wherein the oral examination includes a sight translation test that tests an ability of the qualified candidate to read, comprehend, and interpret a written document into another language.

79. The system of claim 66, wherein the oral examination includes a consecutive interpreting test.

80. The system of claim 66, wherein the oral examination includes (i) a sight translation test that tests an ability of the qualified candidate to read, comprehend, and interpret a written document into another language and (ii) a consecutive interpreting test.

81. The system of claim 66, wherein the oral examination is provided through a live tester.

82. The system of claim 66, wherein the oral examination is provided through an automated system.

83. The system of claim 66, wherein the written examination is proctored at a testing site.

84. The system of claim 66, wherein the written examination is proctored by a manager at a customer location.

85. The system of claim 66, wherein the oral examination is proctored at a testing site.

86. The system of claim 66, wherein the oral examination is proctored by a manager at a customer location.

87. The system of claim 66, wherein the prerequisite is a requirement that has to be met.

88. A computer program product comprising a computer useable medium having a computer readable program, wherein the computer readable program when executed on a computer causes the computer to:
provide, if a language interpreter candidate is a beginning level language interpreter candidate, a preliminary assessment and a language proficiency test;
provide, if the language interpreter has a predetermined amount of entry level language interpreter experience or has completed beginning level language interpreter requirements, an interpreter skills assessment test; and
provide, if the language interpreter candidate has a predetermined amount of professional level language interpreter experience, a predetermined amount of training in a subject matter field associated with the subject matter skill set, or has passed the interpreter skills assessment test, a subject matter skill set language interpretation certification test by (i) providing a screening of a candidate on a prerequisite, (ii) providing a written examination to a qualified candidate, the qualified candidate passing the screening, and (iii) providing an oral examination to the qualified candidate if the qualified candidate passes the written examination; and
provide certification to the qualified candidate if the qualified candidate passes both the written examination and the oral examination.

89. The computer program product of claim 88, wherein the preliminary assessment is, at least in part, a self-assessment.

90. The computer program product of claim 89, wherein the preliminary assessment is web-based.

91. The computer program product of claim 88, wherein the preliminary assessment is oral.

92. The computer program product of claim 88, wherein the preliminary assessment is written.

93. The computer program product of claim 88, wherein the preliminary assessment is live.

94. The computer program product of claim 88, wherein the screening is oral.

95. The computer program product of claim 88, wherein the screening is written.

96. The computer program product of claim 88, wherein the screening is telephonic.

97. The computer program product of claim 88, wherein the screening is web-based.

98. The computer program product of claim 88, wherein the written examination is web-based.

99. The computer program product of claim 98, wherein the written examination is rated by a web-based scoring instrument.

100. The computer program product of claim 88, wherein the oral examination includes a sight translation test that tests an ability of the qualified candidate to read, comprehend, and interpret a written document into another language.

101. The computer program product of claim 88, wherein the oral examination includes a consecutive interpreting test.

102. The computer program product of claim 88, wherein the oral examination includes (i) a sight translation test that tests an ability of the qualified candidate to read, comprehend, and interpret a written document into another language and (ii) a consecutive interpreting test.

103. The computer program product of claim 88, wherein the oral examination is provided through a live tester.

104. The computer program product of claim 88, wherein the oral examination is provided through an automated system.

105. The computer program product of claim 88, wherein the written examination is proctored at a testing site.

106. The computer program product of claim 88, wherein the written examination is proctored by a manager at a customer location.

107. The computer program product of claim 88, wherein the oral examination is proctored at a testing site.

108. The computer program product of claim 88, wherein the oral examination is proctored by a manager at a customer location.

109. The computer program product of claim 88, wherein the prerequisite is a requirement that has to be met.

110. A system comprising:
a communication device based screening module that provides, through the communication device, a screening of a candidate on a prerequisite;
a communication device based written examination module that provides, through the communication device, a written examination that is provided to a qualified candidate, the qualified candidate passing the screening;
an oral examination automated system that provides an oral examination to the qualified candidate if the qualified candidate passes the written examination;
an examination results delivery module that delivers examination results to the qualified candidate; and
a certification module that provides certification to the qualified candidate if the qualified candidate passes both the written examination and the oral examination.

111. The system of claim 110, wherein the communication medium is a web-based server.

112. The system of claim 110, wherein the communication medium is an automated telephone system.
